(19) United States
(12) Patent Application Publication
(10) Pub. No.: US 2014/0311010 A1
(43) Pub. Date: Oct. 23, 2014

(54) FISHING DEVICE

(71) Applicants: Don Talbot, Wenatchee, WA (US); Jesse Brazill, East Wenatchee, WA (US)

(72) Inventors: Don Talbot, Wenatchee, WA (US); Jesse Brazill, East Wenatchee, WA (US)

(21) Appl. No.: 13/866,973

(22) Filed: Apr. 19, 2013

(51) Int. Cl. A01K 85/01

(52) U.S. Cl. CPC A01K 85/01
USPC 43/42.06

(57) ABSTRACT

The instant application discloses, among other things, a Fishing Device with a curved body. The Fishing Device may effect a spiral motion while the Fishing Device moves through water. The Fishing Device may also have a hook garage, which may hold a shank of a hook, or provide storage of a hook while the Fishing Device is not in use.

### FIELD

This disclosure relates generally to a Fishing Device.

### BACKGROUND

Fishermen often use different lures and other devices to catch different species of fish or for different conditions. For example, larger fish may be attracted to a larger lure than a smaller fish. Fish may be found at different depths, and various fishing devices may assist in getting a hook to the right depth. Fish in one lake may look for a different kind of food than similar fish in another lake.

### SUMMARY

The instant application discloses, among other things, a Fishing Device with a curved body. The Fishing Device may effect a spiral motion while the Fishing Device moves through water. The Fishing Device may also have a hook garage, which may hold a shank of a hook, or provide storage of a hook while the Fishing Device is not in use.

The Fishing Device may have a device body, which may have a separable or openable portion incorporating a receptacle for holding bait or scent. The openable portion may be held closed with a fastener, and may be coupled to the device body by a hinge. In one embodiment, a removable piece separable from the device body may be held fast with one or more fasteners. The device body may include scent slots, which may allow fish to detect bait or scent placed in the receptacle.

The Fishing Device may also have a receptacle gripping means for fixedly attaching bait to the device body. The Fishing Device may also provide a way to secure a hook or other means to secure a fish.

The Fishing Device body may be generally straight, or have a plurality of curves, which may effect a motion while the Fishing Device body is being pulled through water. It may be made of various materials, including, for example, wood, plastic, rubber, metal, or carbon fiber, and may be any color including, for example, colors in the visible light spectrum, ultraviolet colors, fluorescent colors, or any other color. It may be used near a hook as a lure, in-line, or in combination with one or more other fishing devices.

### BRIEF DESCRIPTION OF THE DRAWINGS

FIG. 1 illustrates a Fishing Device according to one embodiment.

FIG. 2 illustrates a Fishing Device with an Openable Portion according to one embodiment.

FIG. 3 illustrates a Fishing Device with an Openable Portion according to another embodiment.

FIG. 4 illustrates a Fishing Device with a Wing attached according to one embodiment.

### DETAILED DESCRIPTION

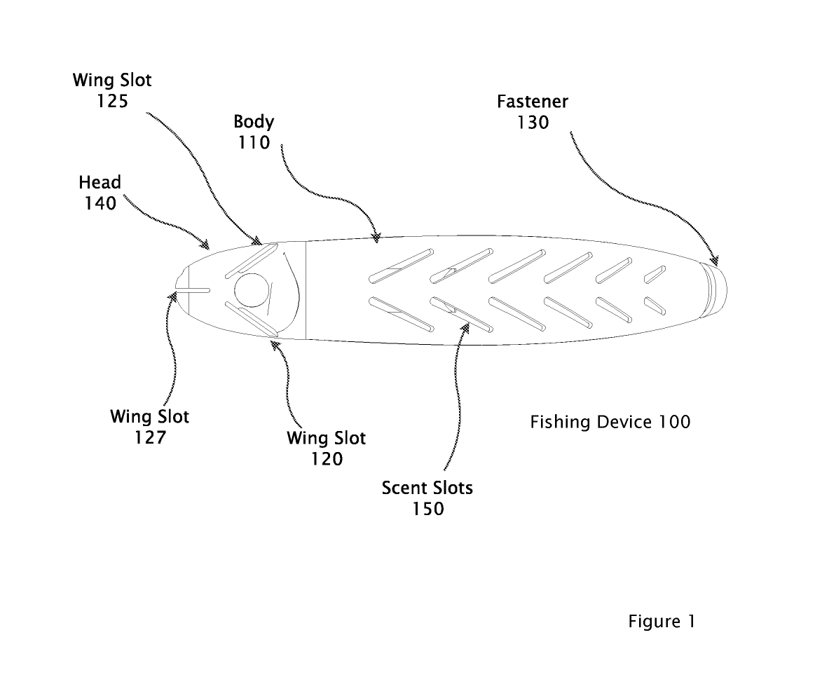

FIG. 1 illustrates a Fishing Device 100 according to one embodiment. Fishing Device 100 may have Body 110, Wing Slot 120, 125, 127 Fastener 130, Head 140, and Scent Slots 150. Wing Slots 120, 125, 127 may be formed on Head 140. Head 140 may be attached to Body 110, which may have an openable or removable portion. A plurality of Scent Slots 150 may allow scent to escape from bait placed internally in Body 110, which may help attract fish.

Body 110 may be approximately fish-shaped. It may be made of various materials, including, for example, wood, plastic, rubber, metal, and may be any color including, for example, colors in the visible light spectrum, ultraviolet colors, fluorescent colors, or any other color. It may be used near a hook as a lure, in-line, or in combination with one or more other fishing devices. Body 110 may be used to hold weight, which may eliminate the need for a separate weight on a Fishing Line 320.

Wing Slots 120, 125, 127 may be placed at different angles, which may provide various types and directions of movements. In one embodiment, the angles may be between 35 and 45 degrees from a longitudinal axis of Fishing Device 100. Wing Slots 120, 125, 127 may be placed symmetrically or asymmetrically; at different angles from one another.

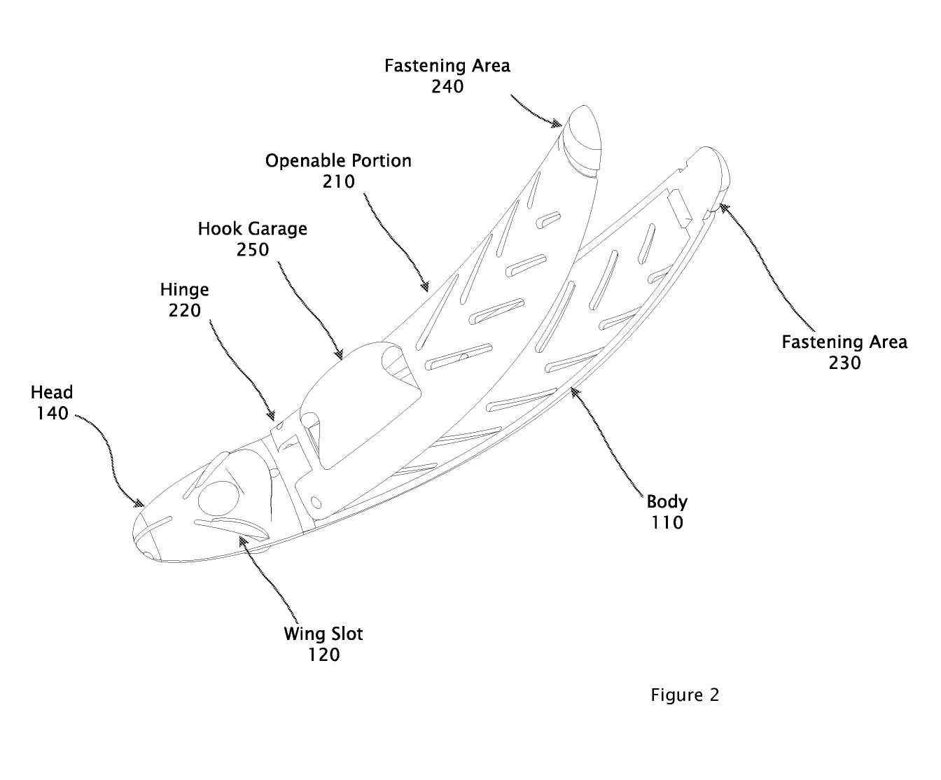

FIG. 2 illustrates Fishing Device 100 with an Openable Portion 210 according to one embodiment. Openable Portion 210 may be attached to Body 110 by Hinge 220. Body 110 and Openable Portion 210 may, when together, form a compartment, which may allow bait or a scent to be contained, which may attract fish.

Fastening Area 240 may fit with Fastening Area 230. A means of holding Fastening Area 240 and Fastening Area 230 may hold Openable Portion 210 against Body 110. In the example illustrated, a rubber band may be placed over Fastening Area 240 and Fastening Area 230. One having skill in the art will recognize that many different ways may be used to hold Openable Portion 210 against Body 110, including, but not limited to, a rubber band, a magnet, a hinged clip, or a tied thread.

Hook Garage 250 may hold a shank of a hook, or may perform as a guide for a Fishing Line 320. It may also store a hook safely while Fishing Device 100 is not being used.

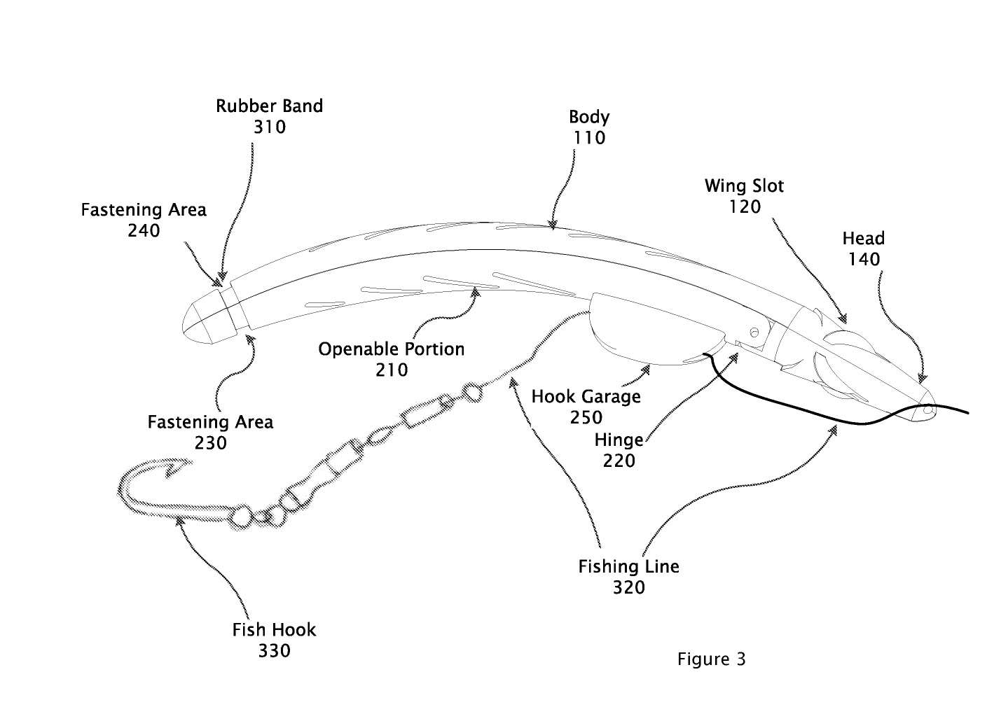

FIG. 3 illustrates a Fishing Device 100 with an Openable Portion 210 according to another embodiment. In this example, Rubber Band 310 may be used to hold Fastening Area 230 to Fastening Area 240, which may keep Openable Portion 210 secure near Body 110, which may allow bait or a scent inside.

In this example, Body 110 and Openable Portion 210 are curved, which may change how Body 110 moves through water.

One having skill in the art will recognize that other means besides Rubber Band 310 may be used to hold Fastening Area 230 to Fastening Area 240, including, for example, an O-ring or surgical tubing.

Fishing Line 320 may have various other devices coupled, which may help attract fish. Fishing Line 320 may be tied or otherwise coupled to Fishing Device 100. Fishing Device 100 may also be used in-line, which may allow Fishing Device 100 to move longitudinally along Fishing Line 320.

Fish Hook 330 may be attached near, for example within six inches, of Fishing Device 100, or may be set further away, depending on a user's preference.

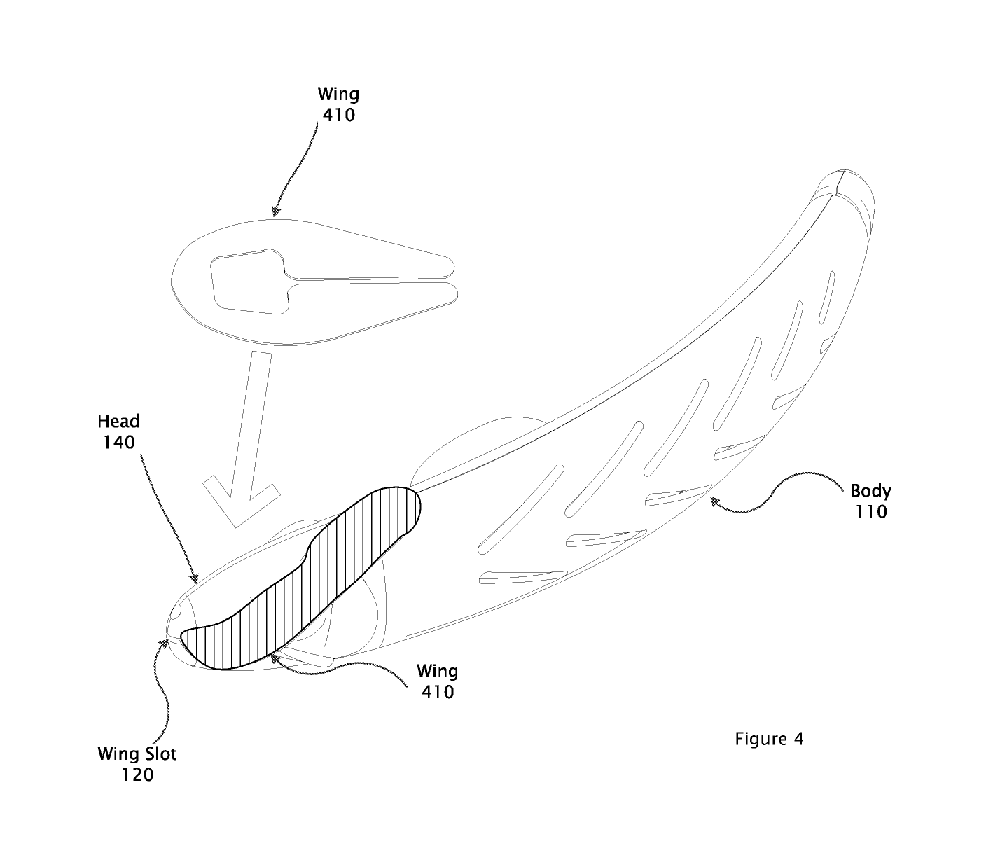

FIG. 4 illustrates a Fishing Device 100 with a Wing 410 attached according to one embodiment. Wing 410 may be shaped to slide over Head 140 and snap into position in one or more of Slots 120, 125, 127. Wing 410 may be made from various materials, and may be reflective or non-reflective, and may be any color. In the example shown, Wing 410 may be made of Mylar, and may slide over Head 140 from a front, sliding into three Wing Slots 120, 125, 127. Wing Slots 125, 127 may be set at angles to spin the Fishing Device in a particular direction when Fishing Device is pulled forward in water.

One having skill in the art will recognize that many different designs of a Fishing Device 100, may fall within the spirit and scope of this disclosure, including, for example, various colors, sizes, and shapes.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description may show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data may not provide a complete description of the manufacture and use of the invention. Since many embodiments of the invention can be made without departing from the spirit and scope of the invention, the invention resides in the claims hereinafter appended.

1. A fishing device, comprising:
A head; and
a body, the body generally fish-shaped, having a front end and a back end, comprising:
a bait compartment, the bait compartment comprising a fixed portion and an openable portion, the openable portion coupled at a first end to the fixed portion by a hinge and coupled at a second end via a first fastening means.

2. The fishing device of claim 1 wherein the body is generally bilaterally symmetrical along a plane passing horizontally through a longitudinal axis.

3. The fishing device of claim 1 wherein the body is curved along a longitudinal axis.

4. The fishing device of claim 1, wherein the body reflects at least a portion of ultraviolet light to which it is exposed.

5. The fishing device of claim 1, wherein the body has a fluorescent color.

6. The fishing device of claim 1 wherein the body is made from one or more materials selected from the group containing wood, plastic, rubber, metal, and carbon fiber.

7. The fishing device of claim 1 wherein the first fastening means is selected from a group containing a rubber band, an O-ring, and surgical tubing.
